(19) United States
(12) Patent Application Publication
(10) Pub. No.: US 2023/0251475 A1
(43) Pub. Date: Aug. 10, 2023

(54) IMAGING LENS, CAMERA MODULE AND ELECTRONIC DEVICE INCLUDING THE SAME

(71) Applicant: LG ELECTRONICS INC., Seoul (KR)

(72) Inventors: Kwanhyung KIM, Seoul (KR); Sangguel OH, Seoul (KR); Jayong LEE, Seoul (KR); Hyungjoo KANG, Seoul (KR); Sunho CHO, Seoul (KR)

(73) Assignee: LG ELECTRONICS INC., Seoul (KR)

(21) Appl. No.: 18/012,784

(22) PCT Filed: Jun. 24, 2020
(86) PCT No.: PCT/KR2020/008223

§ 371 Date: Dec. 23, 2022

(51) Int. Cl. G02B 17/08; G02B 13/00

(52) U.S. Cl. CPC G02B 17/0808; G02B 17/0856; G02B 13/0035; G02B 13/0055; G03B 30/00

(57) ABSTRACT

The present disclosure relates to an imaging lens, a camera module and an electronic device including the same. The imaging lens according to an embodiment of the present disclosure includes a catadioptric lens on which light is incident from an object side, and through which light is reflected and emitted from the inside; and a lens group including a plurality of lenses for transmitting the light emitted from the catadioptric lens to an image surface, wherein the catadioptric lens includes: an incident surface on which light is incident from the object side; a second mirror surface which is formed concave toward the object side, and reflects the light incident on the incident surface to a first mirror surface in the object side; the first mirror surface which is formed, at a central portion of the incident surface, convex toward an image side, and reflects the light reflected from the second mirror surface toward the image side; and an exit surface through which the light reflected from the first mirror surface is emitted, wherein all of the lens group is disposed between the first mirror surface and the second mirror surface based on an optical axis. Accordingly, it is possible to increase the brightness of the lens, increase resolution, suppress an increase in thickness, and reduce tolerance due to mirror assembly.

### TECHNICAL FIELD

The present disclosure relates to an imaging lens, a camera module and an electronic device including the same, and more particularly, to an imaging lens which has all lenses that are located in a space formed in a catadioptric lens including two mirror surfaces, increases the brightness of a lens, and reduces tolerance due to mirror assembly, a camera module and an electronic device including the same.

### BACKGROUND ART

Recently, as the functions of mobile terminals have diversified and their sizes have become slimmer, high performance and thin thickness are required for camera modules mounted in mobile terminals. However, in order to implement a camera having a bright and high telescopic performance, the height or thickness of the camera module must be increased. Thus, there is a limit to miniaturization.

A telephoto camera has a long focal length due to its geometric structure and a long overall length compared to its diameter, thereby making it difficult to be used in a camera that requires a thin thickness such as a smartphone. In order to solve the problem of the thickness of the telephoto camera, recently, a periscope type telephoto camera in which a path of incident light is bent by 90 degrees by using a prism has begun to be used.

FIG. 1 shows a structure of a lens module including a telephoto lens of a conventional periscope type. As shown in FIG. 1, in such a periscope type structure, the lens module is disposed in a mobile terminal in a direction perpendicular to the thickness direction of the mobile terminal. Therefore, when the diameter H1 of the incident light of the lens module is increased, the thickness of the mobile terminal should increase in proportion thereto.

The diameter of the incident light is an important factor affecting the brightness and resolution of the lens. In general, if the diameter of the incident light increases, the brightness Fno of the lens also increases. Therefore, when a periscope type lens module is included in a mobile terminal, there is a limit to increasing the incident light diameter of the lens module.

Accordingly, the brightness of the lens of the telephoto camera of periscope type applied to a mobile terminal is 3.6 or more, which is relatively dark compared to the brightness of general camera lenses.

Meanwhile, in a telescope, a catadioptric optical system using two reflective mirrors is used. A typical telescope is designed to have a lens brightness Fno of 8.0. Therefore, when a telescope lens is applied to a small optical system having a sensor size of about 1 μm, brightness may be excessively low and resolution may be deteriorated. In addition, since the catadioptric lens has a very long overall length compared to the diameter, there is a problem in that it is difficult to apply to a mobile terminal requiring a thin thickness.

Meanwhile, in a catadioptric optical system using two reflective mirrors, it is necessary to assemble two reflective mirrors and lenses to produce an optical system device. In this case, each component included in the optical system needs to adjust the distance and center. Therefore, a catadioptric optical system using two reflective mirrors has a problem in that optical performance may be degraded due to assembly tolerance during an assembly process. In addition, since two reflective mirrors are assembled while being spaced apart from each other, there is a problem in that if an external impact is applied to the optical system, the optical performance of the optical system may deteriorate as the reflective mirror is distorted from its original position.

### DISCLOSURE

### Technical Problem

In order to solve the above problem, an object of the present disclosure is to provide an imaging lens capable of suppressing an increase in the thickness of a lens by locating all lenses in a space formed in a catadioptric lens including two mirror surfaces.

Meanwhile, in order to solve the above problems, an object of the present disclosure is to provide an imaging lens capable of reducing tolerance due to mirror assembly by forming two mirror surfaces on a catadioptric lens.

Meanwhile, in order to solve the above problems, an object of the present disclosure is to provide an imaging lens capable of minimizing deterioration in optical performance of an optical system due to external impact by forming two mirror surfaces on a catadioptric lens.

Meanwhile, in order to solve the above problems, an object of the present disclosure is to provide an imaging lens capable of increasing the brightness performance of a lens by increasing the diameter of entrance pupil compared to the thickness of lens.

Meanwhile, in order to solve the above problems, the present disclosure is to provide an imaging lens capable of increasing lens resolution and removing image noise by allowing a stop surface to exist on an object side surface of a first lens of a lens group, and making the diameter of a transmission area of a second mirror surface to be larger than the diameter of a first mirror surface.

The tasks of the present disclosure are not limited to the tasks mentioned above, and other tasks not mentioned will be clearly understood by those skilled in the art from the following description.

### Technical Solution

An imaging lens according to an embodiment of the present disclosure for achieving the above object includes a catadioptric lens on which light is incident from an object side, and through which light is reflected and emitted from the inside; and a lens group including a plurality of lenses for transmitting the light emitted from the catadioptric lens to an image surface, wherein the catadioptric lens includes: an incident surface on which light is incident from the object side; a second mirror surface which is formed concave toward the object side, and reflects the light incident on the incident surface to a first mirror surface in the object side; the first mirror surface which is formed, at a central portion of the incident surface, convex toward an image side, and reflects the light reflected from the second mirror surface toward the image side; and an exit surface through which the light reflected from the first mirror surface is emitted, wherein all of the lens group is disposed between the first mirror surface and the second mirror surface based on an optical axis.

Meanwhile, in the imaging lens according to an embodiment of the present disclosure for achieving the above object, the exit surface is formed in a planar or aspherical shape.

Meanwhile, in the imaging lens according to an embodiment of the present disclosure for achieving the above object, a stop surface is located between the exit surface and a lens located closest to an image side among the plurality of lenses, on the optical axis.

Meanwhile, in the imaging lens according to an embodiment of the present disclosure for achieving the above object, the exit surface is formed between the first mirror surface and the second mirror surface, based on an optical axis, wherein the second mirror surface includes a circular transmission area centered on an optical axis, wherein the catadioptric lens further includes a side surface connecting a boundary of the transmission area and a boundary of the exit surface, wherein all of the lens group is disposed in a space, which is concave toward an image side, that is formed by the exit surface and the side surface.

Meanwhile, in the imaging lens according to an embodiment of the present disclosure for achieving the above object, an absorption film is coated, or a diffuse pattern is formed on the side surface.

Meanwhile, in the imaging lens according to an embodiment of the present disclosure for achieving the above object, a central point of the transmission area is located between an image side surface of a lens located closest to an image side among the plurality of lenses and the image surface, on the optical axis.

Meanwhile, in the imaging lens according to an embodiment of the present disclosure for achieving the above object, the catadioptric lens is formed of a material having an Abbe number of 50 or more.

Meanwhile, in the imaging lens according to an embodiment of the present disclosure for achieving the above object, the catadioptric lens is formed of a material having a coefficient of thermal expansion of less than or equal to 7×10-6/° C., or a material having a mass per unit volume of 3 g/cm3 or less.

Meanwhile, in the imaging lens according to an embodiment of the present disclosure for achieving the above object, the lens group includes a first lens, a second lens, and a third lens, wherein the first lens and the second lens are an aspherical lense, and wherein the third lens is a Meniscus lens convex to the image side. Meanwhile, in the imaging lens according to an embodiment of the present disclosure for achieving the above object, a radius of curvature of the first mirror surface is greater than a radius of curvature of the second mirror surface.

Meanwhile, in the imaging lens according to an embodiment of the present disclosure for achieving the above object, a diameter D1 of the first mirror surface is smaller than a diameter D2 of a transmission area of the second mirror surface.

Meanwhile, in the imaging lens according to an embodiment of the present disclosure for achieving the above object, the lens group includes a first lens located closest to the object side, wherein a diameter DL1 of the first lens is the smallest among diameters of lenses included in the lens group and is smaller than a diameter D1 of the first mirror surface.

Meanwhile, in the imaging lens according to an embodiment of the present disclosure for achieving the above object, when a diameter of the incident surface is D0 and a distance from the incident surface to the image surface is TTL, a conditional expression of 0<TTL/D0≤0.7 is satisfied.

Meanwhile, in the imaging lens according to an embodiment of the present disclosure for achieving the above object, when an entrance pupil diameter of the imaging lens is EPD and a diameter of transmission area of the second mirror surface is D2, a conditional expression of D2/EPD≤0.8 is satisfied.

Meanwhile, in the imaging lens according to an embodiment of the present disclosure for achieving the above object, a shape of the second mirror surface is in a shape of a flannel lens surface.

Meanwhile, a camera module according to an embodiment of the present disclosure for achieving the above object includes an imaging lens; a filter which selectively transmits light passed through the imaging lens according to a wavelength; and an image sensor which receives light passed through the filter.

Details of other embodiments are included in the detailed description and drawings.

### Advantageous Effects

According to the present disclosure, there are the following effects.

The imaging lens according to an embodiment of the present disclosure suppresses an increase in the thickness of a lens by locating all lenses in a space formed in a catadioptric lens including two mirror surfaces.

In addition, the imaging lens according to an embodiment of the present disclosure reduces tolerance due to mirror assembly by forming two mirror surfaces on a catadioptric lens.

In addition, the imaging lens according to an embodiment of the present disclosure minimizes deterioration in optical performance of an optical system due to external impact by forming two mirror surfaces on a catadioptric lens.

In addition, the imaging lens according to an embodiment of the present disclosure increases the brightness performance of a lens by increasing the diameter of entrance pupil compared to the thickness of lens.

In addition, the imaging lens according to an embodiment of the present disclosure increases lens resolution and removes image noise by allowing a stop surface to exist on an object side surface of a first lens of a lens group, and making the diameter of a transmission area of a second mirror surface to be larger than the diameter of a first mirror surface.

The effects of the present disclosure are not limited to the effects mentioned above, and other effects not mentioned can be clearly understood by those skilled in the art from the description of the claims.

### DESCRIPTION OF DRAWINGS

FIG. 1 is a diagram showing a structure of a conventional periscope-type telephoto lens.

FIG. 2 is a diagram illustrating an imaging lens according to an embodiment of the present disclosure.

FIGS. 3 and 4 show a mobile terminal including an imaging lens according to an embodiment of the present disclosure.

FIG. 5 is a diagram illustrating a path on which light is incident in an imaging lens according to an embodiment of the present disclosure.

FIG. 6 illustrates various examples of a lens group included in the imaging lens of FIG. 2.

FIG. 7 illustrates various examples of a shape of an exit surface included in the imaging lens of FIG. 2.

FIG. 8 illustrates an entrance pupil diameter and a shielding area of the imaging lens of FIG. 2.

FIG. 9 illustrates a phenomenon in which stray light appears according to diameters of a first mirror surface and a second mirror surface in the imaging lens of FIG. 2.

FIG. 10 illustrates various examples of the shape of the second mirror surface in the imaging lens of FIG. 2.

FIG. 11 illustrates various examples of transmission area in the imaging lens of FIG. 2.

FIG. 12 shows each surface of the imaging lens of FIG. 2.

FIG. 13 is an MTF chart according to an incident angle of light in the imaging lens of FIG. 2.

FIG. 14 is a graph showing distortion aberration of the imaging lens of FIG. 2.

FIG. 15 shows a result of comparing an image photographed using the imaging lens of FIG. 2 with an image photographed using a conventional lens.

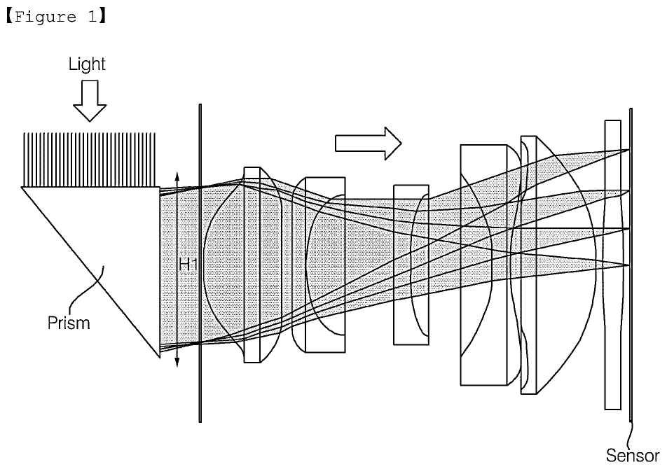

### MODE FOR INVENTION

Description will now be given in detail according to exemplary embodiments disclosed herein, with reference to the accompanying drawings. The same or equivalent components may be denoted by the same reference numbers, and description thereof will not be repeated. In general, suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present

A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

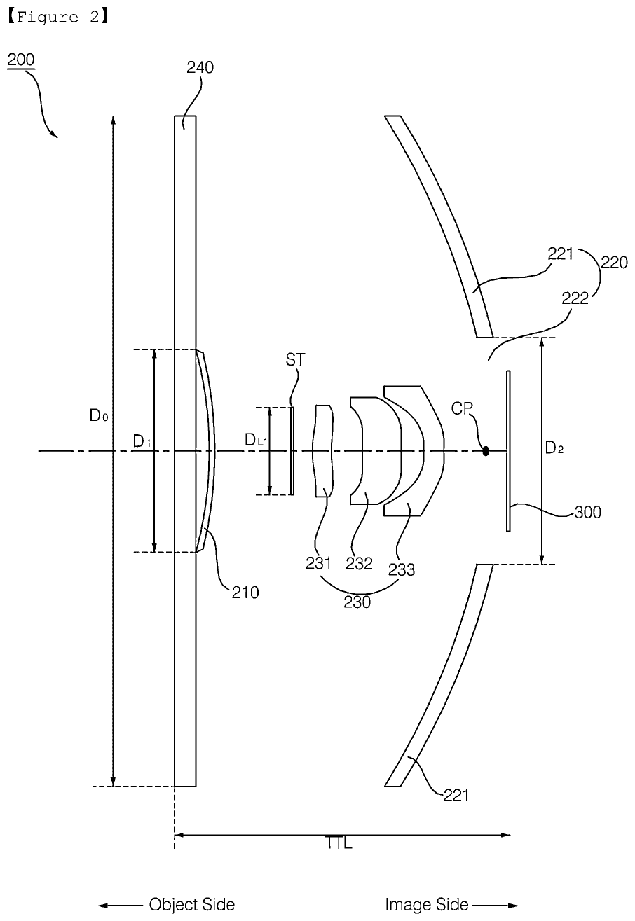

FIG. 2 is a diagram illustrating an imaging lens 200 according to an embodiment of the present disclosure. In FIG. 2, a spherical or aspherical shape of a mirror and a lens is given just as an example, but is not limited thereto.

In the present disclosure, the term ‘target surface’ refers to the surface of a lens facing an object side based on an optical axis, and the term ‘image formation surface’ refers to the surface of a lens facing an image side based on an optical axis. The ‘target surface’ may be defined as the same meaning as the ‘object side surface’, and the ‘image formation surface’ may be defined as the same meaning as the ‘image side surface’.

In addition, in the present disclosure, the ‘image surface’ refers to a surface on which light passing through a lens is formed as an image. In the present disclosure, a light-receiving surface of the image sensor may be located in the ‘image surface’. Therefore, in the description of the camera module or an electronic device including the camera module of the present disclosure, ‘image surface’ and ‘image sensor surface’ may be interpreted as the same meaning.

Further, in the present disclosure, “positive power” of a mirror or lens denotes a converging mirror or converging lens that converges parallel light, and “negative power” of a mirror or lens denotes a diverging mirror or diverging lens that diverges parallel light.

Referring to FIG. 2, the imaging lens 200 may include a catadioptric lens 220 and a lens group 230.

The catadioptric lens 220 may include a first mirror surface 221, an incident surface 222, a second mirror surface 223, an exit surface 224, and a side surface 225.

The incident surface 222 is a surface on which light enters the imaging lens 200 from the object side. The incident surface 222 may be planar.

The second mirror surface 223 is a surface that reflects light incident on the incident surface 222 to the first mirror surface 221 of the object side. To this end, the second mirror surface 223 may be a surface that has a positive power and is formed to be concave (convex toward the image side) toward the object side.

The first mirror surface 221 is a surface that reflects the light reflected by the second mirror surface 223 toward the image side. To this end, the first mirror surface 221 may be a surface that has a negative power and is formed to be convex toward the image side (concave toward the object side) at the center of the incident surface 222.

A reflective layer may be formed on a mirror surface (reflecting surface) of the first mirror surface 221 and the second mirror surface 223 to reflect light. The reflective layer may be formed of a material having excellent reflective properties, for example, a material composed of Ag, Ni, Al, Rh, Pd, Ir, Ru, Mg, Zn, Pt, Au, Hf, or a combination thereof.

The size (diameter) of the first mirror surface 221 can be changed by adjusting the refractive power of the second mirror surface 223. For example, as the refractive power of the second mirror surface 223 becomes higher (increases), the diameter of the first mirror surface 221 may decrease.

The exit surface 224 is a surface from which light reflected by the first mirror surface 221 is emitted. The exit surface 224 may be planar, but the shape of the exit surface 224 is not limited thereto.

The lens group 230 may include a plurality of lenses that transmit the light reflected from the first mirror surface 221 to the image surface, and all of the lens group 230 may be disposed between the second mirror surface 223 and the first mirror surface 221 based on an optical axis. Although the drawing illustrates that the lens group 230 includes three lenses, the number of lenses included in the lens group 230 is not limited thereto.

The lens group 230 may focus the light reflected by the first mirror surface 221, and may suppress aberration through a plurality of lenses included in the lens group.

At least one of the plurality of lenses included in the lens group 230 may include an aspheric lens, and all of the plurality of lenses may have a rotationally symmetrical shape with respect to an optical axis.

Meanwhile, the catadioptric lens 220 and the lens group 230 may be made of a glass material or a plastic material. When the lens is made of a plastic material, manufacturing cost can be greatly reduced.

In the imaging lens 200 having such a structure, the light incident through the incident surface 222 of the catadioptric lens 220 may converge while being reflected toward the object side from the second mirror surface 223, the light reflected from the second mirror surface 223 may be reflected again toward the image side from the first mirror surface 221, and the light reflected from the first mirror surface 221 may penetrate the lens group 230 and proceed to the image sensor 300.

Accordingly, the path of the light entering the imaging lens 200 is overlapped by the first mirror surface 221 and the second mirror surface 223. Thus, the length of the imaging lens 200 may be reduced.

In addition, since all of the lens group 230 are located between the first mirror surface 221 and the second mirror surface 223, an increase in the length of the imaging lens 200 may be suppressed.

In addition, since the two mirror surfaces 221 and 223 are formed on the catadioptric lens 220, deterioration in optical performance due to external shock may be prevented compared to an optical system including two reflection mirrors that are spaced apart.

In addition, since the two mirror surfaces 221 and 223 are formed on the catadioptric lens 220, the process of assembling the mirror of the imaging lens 200 becomes unnecessary. Therefore, tolerance due to mirror assembly can be eliminated.

In addition, the brightness Fno of the lens may be increased and resolution may be improved by increasing the entrance pupil diameter of the imaging lens 200.

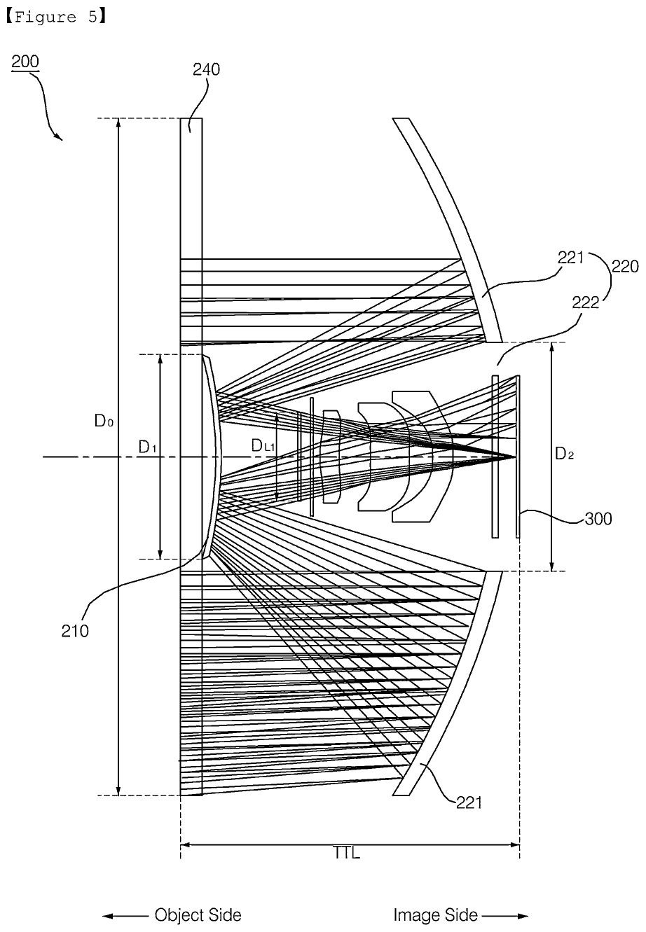

A detailed structure of the imaging lens 200 according to the present disclosure will be described in detail with reference to FIGS. 5 to 11 below.

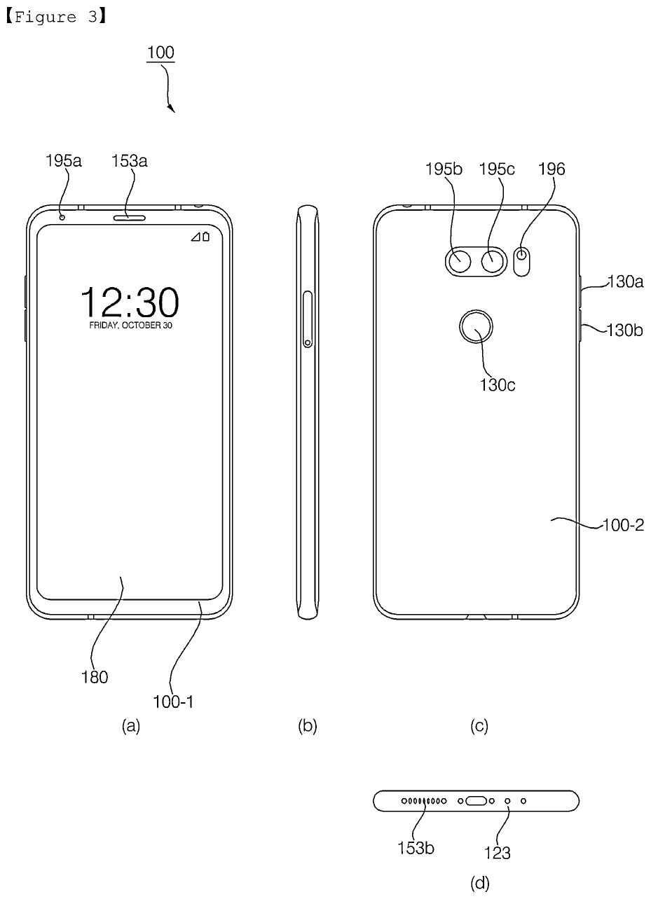

FIG. 3 is a diagram illustrating an outer shape of the mobile terminal 100 including the imaging lens 200 according to an embodiment of the present disclosure. FIG. 3A is a front view of the mobile terminal 100, FIG. 3B is a side view, FIG. 3C is a rear view, and FIG. 3D is a bottom view.

Referring to FIG. 3, a case constituting the outer shape of the mobile terminal 100 is formed by a front case 100-1 and a rear case 100-2. Various electronic components may be embedded in a space formed by the front case 100-1 and the rear case 100-2.

Specifically, a display 180, a first camera device 195a, a first sound output module 153a, and the like may be disposed in the front case 100-1. In addition, a first user input unit 130a and a second user input unit 130b may be disposed in the side surface of the rear case 100-2.

The display 180 may operate as a touch screen as touch pads overlap in a layer structure.

The first sound output module 153a may be implemented in the form of a receiver or a speaker. The first camera device 195a may be implemented in a form suitable for photographing an image or moving image of a user or the like. In addition, a microphone 123 may be implemented in a form suitable for receiving a user's voice or other sounds.

The first and second user input units 130a and 130b and a third user input unit 130c described below may be collectively referred to as a user input unit 130.

A first microphone (not shown) may be disposed in the upper side of the rear case 100-2, that is, in the upper side of the mobile terminal 100, to collect audio signals, and a second microphone 123 may be disposed in the lower side of the rear case 100-2, that is, in the lower side of the mobile terminal 100 to collect audio signals.

A second camera device 195b, a third camera device 195c, a flash 196, and a third user input unit 130c may be disposed in the rear surface of the rear case 100-2.

The second and third camera devices 195b and 195c may have a photographing direction substantially opposite to that of the first camera device 195a, and may have pixels different from those of the first camera device 195a. The second camera device 195b and the third camera device 195c may have a different angle of view to expand a photographing range. A mirror (not shown) may be additionally disposed adjacent to the third camera device 195c. In addition, another camera device may be further installed adjacent to the third camera device 195c, and used to photograph a 3D stereoscopic image or to photograph an additional angle of view.

The second camera device 195b or the third camera device 195c may include the imaging lens 200 according to an embodiment of the present disclosure. In this case, the camera device including the imaging lens 200 may operate as a telephoto lens camera that has a narrow angle of view and photographs a distant subject.

A flash 196 may be disposed adjacent to the second camera device 195b or the third camera 195c. The flash 196 emits light toward a subject when the subject is photographed by the second camera device 195b or the third camera 195c.

A second sound output module 153b may be additionally disposed in the rear case 100-2. The second sound output module may implement a stereo function together with the first sound output module 153a, and may be used for a call in a speaker phone mode.

A power supply unit 190 for supplying power to the mobile terminal 100 may be mounted in the rear case 100-2 side. The power supply unit 190 may be, for example, a rechargeable battery, and may be configured in the rear case 100-2 as one body or detachably coupled to the rear case 100-2 for charging or the like.

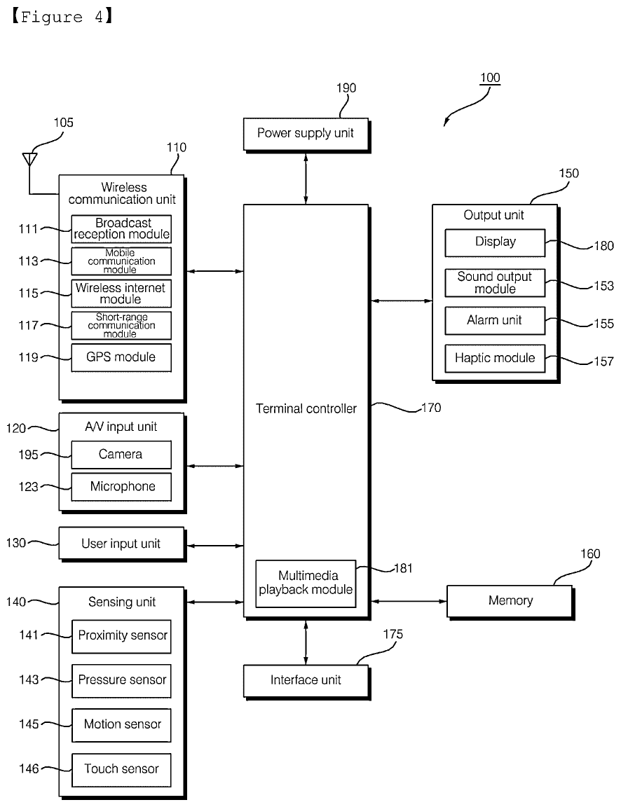

FIG. 4 is a block diagram of the mobile terminal 100 of FIG. 3.

Referring to FIG. 4, the mobile terminal 100 may include a wireless communication unit 110, an audio/video (A/V) input unit 120, a user input unit 130, a sensing unit 140, an output unit 150, a memory 160, an interface unit 175, a terminal controller 170, and a power supply unit 190. When these components are implemented in actual applications, two or more components may be combined into one component, or one component may be subdivided into two or more components as needed.

The wireless communication unit 110 may include a broadcast reception module 111, a mobile communication module 113, a wireless Internet module 115, a short range communication module 117, and a GPS module 119.

The broadcast reception module 111 may receive at least one of a broadcast signal and broadcast-related information from an external broadcast management server through a broadcast channel. A broadcast signal and/or broadcast-related information received through the broadcast reception module 111 may be stored in the memory 160.

The mobile communication module 113 may transmit and receive radio signals with at least one of a base station, an external terminal, and a server on a mobile communication network. Here, the wireless signal may include a voice call signal, a video call signal, or various types of data according to transmission/reception of text/multimedia message.

The wireless Internet module 115 may mean a module for wireless Internet access, and the wireless Internet module 115 may be built into or external to the mobile terminal 100.

The short range communication module 117 may mean a module for short range communication. Bluetooth, Radio Frequency Identification (RFID), Infrared Data Association (IrDA), Ultra Wideband (UWB), ZigBee, Near Field Communication (NFC), and the like may be used as a short range communication technology.

A Global Position System (GPS) module 119 may receive location information from a plurality of GPS satellites.

The audio/video (A/V) input unit 120 is for inputting an audio signal or a video signal, and may include a camera device 195 and a microphone 123.

The camera device 195 may process an image frame such as a still image or a moving image obtained by an image sensor in a video call mode or a photographing mode. In addition, the processed image frame may be displayed on the display 180.

The camera device 195 may include the imaging lens 200 according to an embodiment of the present disclosure.

The image frame processed by the camera device 195 may be stored in the memory 160 or transmitted to the outside through the wireless communication unit 110. Two or more camera devices 195 may be provided according to the configuration of the electronic device.

The microphone 123 may receive an external audio signal through a microphone in a display off mode, for example, a call mode, a recording mode, or a voice recognition mode, and process it into electrical voice data.

Meanwhile, a plurality of microphones 123 may be disposed in different positions. The audio signal received by each microphone may be audio signal-processed by the terminal controller 170 or the like.

The user input unit 130 generates key input data input by a user to control the operation of the electronic device. The user input unit 130 may include a key pad, a dome switch, and a touch pad (resistive/capacitive) capable of receiving command or information through a user's press or touch operation. In particular, when the touch pad forms a mutual layer structure with the display 180 described later, it may be referred to as a touch screen.

The sensing unit 140 may generate a sensing signal for controlling the operation of the mobile terminal 100 by detecting the current state of the mobile terminal 100, such as the open/closed state of the mobile terminal 100, the location of the mobile terminal 100, a contact of user.

The sensing unit 140 may include a proximity sensor 141, a pressure sensor 143, a motion sensor 145, a touch sensor 146, and the like.

The proximity sensor 141 may detect an object approaching the mobile terminal 100 or an object existing near the mobile terminal 100 without mechanical contact. In particular, the proximity sensor 141 may detect a proximity object by using a change in an alternating magnetic field or a change in a static magnetic field, or a rate of change in capacitance.

The pressure sensor 143 may detect whether pressure is applied to the mobile terminal 100, and a magnitude of the pressure.

The motion sensor 145 may detect a position or movement of the mobile terminal 100 by using an acceleration sensor, a gyro sensor, or the like.

The touch sensor 146 may detect a touch input by a user's finger or a touch input by a specific pen. For example, when a touch screen panel is disposed on the display 180, the touch screen panel may include a touch sensor 146 for detecting location information and intensity information of a touch input. A sensing signal detected by the touch sensor 146 may be transmitted to the terminal controller 170.

The output unit 150 is for outputting an audio signal, a video signal, or an alarm signal. The output unit 150 may include a display 180, a sound output module 153, an alarm unit 155, and a haptic module 157.

The display 180 displays and outputs information processed by the mobile terminal 100. For example, when the mobile terminal 100 is in a call mode, a UI (User Interface) or GUI (Graphic User Interface) related to a call is displayed. In addition, when the mobile terminal 100 is in a video call mode or a photographing mode, photographed or received image may be displayed individually or simultaneously, and a UI and GUI are displayed.

Meanwhile, as described above, when the display 180 and the touch pad form a mutual layer structure to form a touch screen, the display 180 may be used as an input device capable of inputting information by a user's touch, in addition to an output device.

The sound output module 153 may output audio data which is received from the wireless communication unit 110 or stored in the memory 160 in a call signal reception mode, a call mode or a recording mode, a voice recognition mode, or a broadcast reception mode. In addition, the sound output module 153 outputs an audio signal related to function performed by the mobile terminal 100, for example, a call signal reception sound and a message reception sound. The sound output module 153 may include a speaker, a buzzer, and the like.

The alarm unit 155 outputs a signal for notifying occurrence of an event in the mobile terminal 100. The alarm unit 155 outputs a signal for notifying occurrence of an event in a form other than an audio signal or a video signal. For example, a signal may be output in the form of a vibration.

The haptic module 157 generates various tactile effects that a user can feel. A representative example of the tactile effect generated by the haptic module 157 is a vibration effect. When the haptic module 157 generates vibration as a tactile effect, the intensity and pattern of the vibration generated by the haptic module 157 may be changed, and different vibrations may be synthesized and output or sequentially output. The memory 160 may store a program for the process and control of the terminal controller 170, and may also perform a function for temporarily storing input or output data (e.g. phonebook, message, still image, video, etc.).

The interface unit 175 serves as an interface with all external devices connected to the mobile terminal 100. The interface unit 175 may receive data or receive power from an external device and transmit to each component inside the mobile terminal 100, and may transmit data inside the mobile terminal 100 to an external device.

The mobile terminal 100 may include a fingerprint recognition sensor for recognizing a user's fingerprint, and the terminal controller 170 may use fingerprint information detected through the fingerprint recognition sensor as an authentication means. The fingerprint recognition sensor may be embedded in the display 180 or the user input unit 130.

The terminal controller 170 typically controls the overall operation of the mobile terminal 100 by controlling the operation of each unit. For example, it may perform related control and processing for voice call, data communication, video call, and the like. In addition, the terminal controller 170 may include a multimedia playback module 181 for playing multimedia. The multimedia playback module 181 may be configured as hardware inside the terminal controller 170 or may be configured as software separately from the terminal controller 170.

Meanwhile, the terminal controller 170 may include an application processor (not shown) for driving an application. Alternatively, the application processor (not shown) may be provided separately from the terminal controller 170.

In addition, the power supply unit 190 may receive external power and internal power under the control of the terminal controller 170 and supply power necessary for the operation of each component.

The power supply unit 190 may have a connection port, and the connection port may be electrically connected to an external charger that supplies power to charge a battery. Meanwhile, the power supply unit 190 may charge a battery in a wireless manner without using the connection port.

FIG. 5 is a diagram illustrating an incident path of light in the imaging lens 200 according to an embodiment of the present disclosure.

Referring to FIGS. 2 and 5 together, in the catadioptric lens 220, the exit surface 224 may be formed between the first mirror surface 221 and the second mirror surface 223 based on the optical axis. In addition, the exit surface 224 may be a circular surface perpendicular to the optical axis, with the optical axis as the center.

Meanwhile, the catadioptric lens 220 may further include a side surface 225 and a transmission area 226.

A circular hole having a cross section perpendicular to the optical axis may be formed in the second mirror surface 223. Such a circular hole may be defined as the transmission area 226.

The transmission area 226 is an area through which light transmitted through the lens group 230 proceeds to the image sensor 300.

When viewed from a plane perpendicular to the optical axis, the second mirror surface 223 and the transmission area 226 may have a circular shape, and the center of the transmission area 226 may coincide with the center of the second mirror surface 223.

The side surface 225 may be a surface connecting a boundary of the hole of the transmission area 226 and a circular boundary of the exit surface 224. That is, a space which is concave toward the image side may be formed in the catadioptric lens 220 by the side surface 225 and the exit surface 224. In this space, a cross section parallel to the optical axis may be a trapezoid, and a cross section perpendicular to the optical axis may be a circle. That is, such a space may have a frustum of cone shape. In the present disclosure, a corresponding space is referred to as a lens accommodating portion.

However, the shape of the side surface 225 is not limited thereto, and depending on the shape of the side surface 225 and the exit surface 224, the shape of the lens accommodating portion may also be formed in a shape other than a frustum of cone shape.

Meanwhile, an absorption film may be coated or a diffuse pattern may be formed in the side surface 225.

The absorption film may include an acrylic or vinyl resin containing light absorbing dyes. The diffuse pattern may be a rough or porous surface pattern. Meanwhile, a diffuse reflection film may be attached to the side surface 224.

Accordingly, a ghost image generated when some of the light incident to the catadioptric lens 220 is reflected from the side surface 224 may be suppressed.

Meanwhile, the radius of curvature of the first mirror surface 221 may be greater than that of the second mirror surface 223.

The size (diameter) of the first mirror surface 221 may be changed by adjusting the refractive power of the second mirror surface 223. For example, as the refractive power of the second mirror surface 223 increases (becomes greater), the diameter of the first mirror surface 221 may decrease.

Therefore, the radius of curvature of the second mirror surface 223 is formed smaller than the radius of curvature of the first mirror surface 221, so that the angle of the light reflected from the second mirror surface 223 can be increased. Accordingly, the diameter of the first mirror surface 221 can be reduced, and the size of the shielding area can be minimized.

Meanwhile, the catadioptric lens 220 may be formed of glass or plastic material. Preferably, the catadioptric lens 220 may be formed of a glass material.

A material forming the catadioptric lens 220 may have a coefficient of thermal expansion of 7×10-6/° C. or less. When the coefficient of thermal expansion is greater than or equal to 7×10-6/° C., the shape of the catadioptric lens 220 may change according to temperature change, and thus, the optical performance of the catadioptric lens 220 may decrease.

Meanwhile, the catadioptric lens 220 may be formed of a material having an Abbe Number of 50 or more. The higher the Abbe number, the less variance occurs. When the Abbe number of the material forming the catadioptric lens 220 is less than 50, chromatic aberration generated in the catadioptric lens 220 may increase.

Meanwhile, a material forming the catadioptric lens 220 may have a mass (density) per unit volume of 3 g/cm3 or less. When the mass per unit volume exceeds 3 g/cm3, the catadioptric lens 220 is too heavy, and thus it may be difficult to move the catadioptric lens 220 for focusing. In addition, the catadioptric lens 220 may be easily damaged by an impact when the optical device is dropped.

Referring to FIGS. 2 and 5 together, the lens group 230 may include a plurality of lenses disposed along an optical axis from the object-side surface to the image-side surface. It is assumed that the lenses included in the lens group 230 are a first to Nth lenses (N is a natural number greater than or equal to 2) sequentially from the object-side surface to the image-side surface. Although three lenses are shown in the drawing, the number of lenses included in the lens group 230 is not limited thereto.

All of the plurality of lenses included in the lens group 230 may be located between the first mirror surface 221 and the second mirror surface 223. In detail, all of the plurality of lenses included in the lens group 230 may be located inside the lens accommodating portion formed by the side surface 225 and the exit surface 224. In the lens group 230, the object side surface of the first lens 231 located closest to the object side may be spaced apart from the exit surface 224 and located closer in the image side than the exit surface 224.

In addition, in the lens group 230, a Nth lens located closest to the image side may be located farther from the image sensor 300 than the second mirror surface 223. The transmission area 226 has a circular shape existing on a plane perpendicular to the optical axis. Accordingly, the center point (CP in FIG. 2) of the transmission area 226 may be located between the image surface and the image side surface of the Nth lens, on the optical axis.

Meanwhile, the image sensor 300 may be located within the transmission area 226. In this case, the center point CP of the transmission area 226 may coincide with the image surface, on the optical axis, and the image side surface of the Nth lens may be located closer to the object side than the center point CP of the transmission area 226 or the image surface, on the optical axis.

Accordingly, all the lens group 230 are located between the first mirror surface 221 and the second mirror surface 223, so that an increase in the length of the imaging lens 200 can be suppressed.

The image sensor 300 is a device that forms an image of a subject passing through the imaging lens 200. The image sensor 300 may include a plurality of pixels disposed in a matrix form. The image sensor 300 may include at least one photoelectric conversion device capable of converting an optical signal into an electrical signal. For example, the image sensor 300 may be a charge-coupled device CCD or a complementary metal-oxide semiconductor CMOS.

Meanwhile, the image sensor 300 may be divided into a first area 310 at the center of the sensor and a second area 320 at the periphery of the sensor.

The first area 310 may include a plurality of pixels, and a corresponding pixel may have a first pixel density. The second region 320 may include a plurality of pixels, and a corresponding pixel may have a first pixel density. Here, pixel density may be defined as the number of pixels per unit area.

The first pixel density may be greater than the second pixel density. In this case, since the resolution of the first area 310, which is the central area of the image sensor 300, is increased, the photographing resolution of a subject located in the center of the field of view of the imaging lens 200 may be increased.

Meanwhile, the second pixel density may be greater than the first pixel density. In this case, since the resolution of the second area 320, which is the peripheral area of the image sensor 300, is increased, the photographing resolution of a subject located in the periphery of the field of view of the imaging lens 200 may be increased. Accordingly, deterioration in image quality due to the periphery of the imaging lens 200 can be suppressed through the image sensor 300.

Meanwhile, referring to FIG. 5, the diameter DL1 of the first lens of the lens group 230 may be the smallest among the diameters of lenses included in the lens group 230. In addition, the diameter DL1 of the first lens may be smaller than the diameter D1 of the first mirror surface 221 and the diameter D2 of the transmission area 226 of the second mirror surface 223.

The diameter DL1 of the first lens is smaller than the diameter of the other lens, the diameter of the first mirror surface 221, and the diameters of the transmission area 226, so that the stop surface (ST of FIG. 2) of the imaging lens 200 of the present disclosure is located between the exit surface 224 and the object side surface of the first lens 231.

Here, stop means an aperture stop, and means a physical iris diaphragm that determines the size of light entering the lens. The stop surface can be the surface or iris of an optical lens, but always exists as a physical surface.

As described above, the stop surface of the imaging lens 200 is located between the exit surface 224 and the object-side surface of the first lens 231, thereby reducing the size of the shielding area (an area in which some of the light incident on the imaging lens 200 is blocked and does not reach the image sensor) of the imaging lens 200. Accordingly, it is possible to minimize the amount of shielded light among the light entering the imaging lens 200 and to reduce the Fno (F-number) of the imaging lens 200.

Meanwhile, a stop surface of the imaging lens 200 may include a diaphragm device. The diaphragm device may adjust the amount of light incident on the lens of the lens group 230 from among the light reflected by the second mirror surface 223 and the first mirror surface 221.

The diaphragm may have a mechanical structure capable of gradually increasing or decreasing the size of an opening so as to adjust the amount of incident light. The amount of incident light increases as the opening of the diaphragm device becomes larger, and the amount of incident light decreases as the opening becomes smaller.

In this case, a processor (not shown) of the camera module may control a driving circuit (not shown) so that the opening of the diaphragm device is variable, thereby adjusting the amount of light incident to the image sensor 300.

Meanwhile, an absorption film or the like may be coated on the object-side surface of the first mirror surface 221. Due to the absorption film, unnecessary reflection of light incident on the shielding area of the incident surface 222 may be suppressed. Meanwhile, since the reflective layer is formed on the first mirror surface 221, the absorption film may be additionally formed on a reflective layer formed on the first mirror surface 221.

Meanwhile, in the present disclosure, the distance from the incident surface 222 to the image surface may be referred to as a thickness (Total Top Length or Total Track Length: TTL) of the imaging lens 200.

The thickness of the imaging lens 200 may be relatively small compared to the diameter D0 of the incident surface 222. Here, the diameter of the incident surface 222 may be the same as that of the imaging lens 200. Specifically, the thickness of the imaging lens 200 may be designed to be equal to or less than 0.7 times the diameter D0 of the incident surface 222.

That is, the thickness of the imaging lens 200 and the diameter D0 of the incident surface 222 may satisfy a conditional expression of 0<TTL/D0≤0.7.

If the TTL/D0 value is greater than 0.7, when the diameter of the entrance pupil is increased to increase lens brightness, the imaging lens 200 becomes thicker. Thus, it may be difficult to mount on a mobile terminal or the like.

Meanwhile, the imaging lens 200 according to an embodiment of the present disclosure may satisfy the following conditional expression.

0<Fn≤3.5

Here, Fno is a constant indicating the brightness of the imaging lens 200. As Fno increases, the brightness of the imaging lens 200 decreases, and the amount of light received by the imaging lens 200 in the same environment decreases.

If Fno is greater than 3.5, the quality of an image acquired by the imaging lens 200 in a dark place is degraded. Therefore, in the imaging lens 200 of the present disclosure, the diameter of the entrance pupil may be increased through a structure of two mirrors and the lens group located between the mirrors, and Fno may be 3.5 or less.

In a lens having a conventional periscope structure, the diameter of the entrance pupil cannot be increased beyond a certain size in order not to increase the thickness of the mobile terminal. Therefore, it is difficult that Fno is equal to or less than 3.5 in the lens of the conventional periscope structure.

Meanwhile, the imaging lens 200 according to an embodiment of the present disclosure may satisfy the following conditional expression.

ANG≤6°

Here, ANG is a numerical value indicating the half angle of view of the imaging lens 200. The half angle of view means ½ of the entire angle of view of the imaging lens 200.

The imaging lens 200 of the present disclosure may be designed to have an ANG of 6 degrees or less, and accordingly, as a telephoto lens, may allow to photograph an image including a subject at a distance.

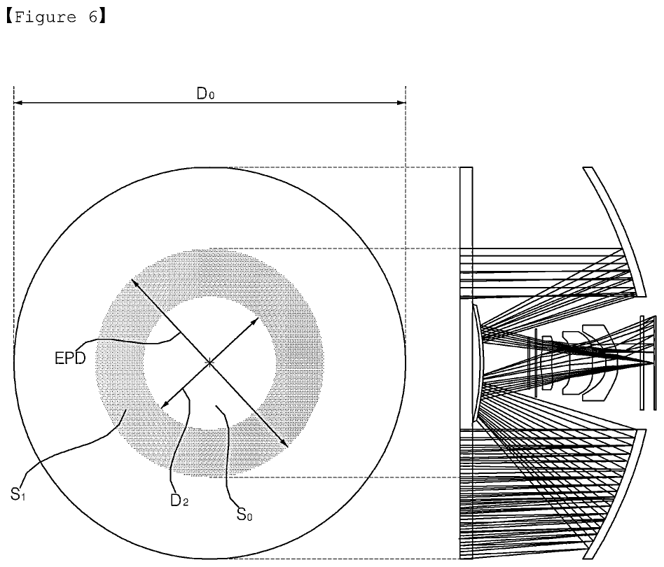

FIG. 6 illustrates various examples of the lens group 230 included in the imaging lens 200 of FIG. 2.

Referring to FIG. 6A, the lens group 230 may include a plurality of lenses. In this example, three lenses are included in the lens group 230, but the number of lenses included in the lens group 230 is not limited thereto.

At least one of the first lens 231 to the third lens 233 may include an aspherical lens, and all of the lenses may have a rotationally symmetrical shape based on an optical axis.

In addition, the first lens 231 to the third lens 233 may be made of a glass material or a plastic material. When the lens is made of a plastic material, manufacturing cost can be greatly reduced.

The first lens 231 may be disposed closest to the object side, and a target surface may be convex toward the object side and an image formation surface may be concave toward the image side. The first lens 231 may have the smallest diameter among all lenses included in the lens group 230.

At least one of a target surface and an image formation surface of the first lens 231 may have at least one inflection point. For example, the target surface may be convex in the paraxial region and then concave toward an edge, and the image formation surface may be concave in the paraxial region and then convex toward an edge. However, the shape of the first lens 231 is not limited thereto.

The second lens 232 may be disposed spaced apart from the image formation surface of the first lens 231, and may have a target surface convex toward the object side and an image formation surface convex toward the image side. The second lens 232 may have the thickest thickness in the optical axis in the optical axis direction among all the lenses included in the lens group 230. The diameter of the second lens 232 may be equal to or larger than that of the first lens 231.

At least one of the target surface and the image formation surface of the second lens 232 may have at least one inflection point. For example, the target surface may be convex in the paraxial region and then concave toward an edge, and the image formation surface may be convex in the paraxial region and then concave toward an edge. However, the shape of the second lens 232 is not limited thereto.

The third lens 233 may be disposed spaced apart from the image formation surface of the second lens 232, and the target surface may be concave toward the object side and the image formation surface may be convex toward the image side. That is, the third lens 233 may have a meniscus shape convex toward the image side. However, the shape of the third lens 233 is not limited thereto.

The third lens 233 may be disposed closest to the image side among all the lenses included in the lens group 230. The diameter of the third lens 233 may be equal to or larger than that of the second lens 232.

At least one of the first lens 231 to the third lens 233 includes an aspheric lens, thereby reducing astigmatism, spherical aberration, coma aberration, distortion aberration, and the like occurring on the off-axis.

Meanwhile, the surfaces of the first lens 231 to the third lens 233 may be coated to prevent reflection or improve surface hardness.

Meanwhile, in the plurality of lenses included in the lens group 230, the diameter of each lens may be the same or increase, from a first lens located in the object side to a Nth lens located in the image side.

Specifically, when the diameters of the first lens to the Nth lens are DL1 to DLN, respectively,

a conditional expression of DL1≤DL2≤ . . . ≤DLN−1≤DLN may be satisfied.

If the diameter of the lens located in the image side is smaller than the diameter of the lens located ion the object side (if the above conditional expression is not satisfied), some of the light incident on the lens group 230 may not be received by the image sensor 300.

Meanwhile, referring to FIG. 6B, at least one of the first lens 231 to the third lens 233 may include an aspherical lens, and all of the lenses may have a rotationally symmetrical shape based on an optical axis.

In addition, the first lens 231 to the third lens 233 may be made of a glass material or a plastic material. When the lens is made of a plastic material, manufacturing cost can be greatly reduced.

The first lens 231 is disposed closest to the object side, the target surface is convex toward the object side, and the image formation surface may be a planar shape or a shape convex toward the image side. The first lens 231 may have the smallest diameter among all lenses included in the lens group 230.

At least one of the target surface and the image formation surface of the first lens 231 may have at least one inflection point. For example, the target surface may be convex in the paraxial region and then concave toward an edge, and the image formation surface may be planar in the paraxial region and then convex toward an edge. However, the shape of the first lens 231 is not limited thereto.

The second lens 232 may be disposed spaced apart from the image formation surface of the first lens 231, and the target surface may be concave toward the object side and the image formation surface may be convex toward the image side. The second lens 232 may have the thickest thickness in the optical axis in the optical axis direction among all the lenses included in the lens group 230. The diameter of the second lens 232 may be equal to or larger than that of the first lens 231.

At least one of the target surface and the image formation surface of the second lens 232 may have at least one inflection point. For example, the target surface may be concave in the paraxial region and then convex toward an edge, and the image formation surface may be convex in the paraxial region and then concave toward an edge. However, the shape of the second lens 232 is not limited thereto.

The third lens 233 may be disposed spaced apart from the image formation surface of the second lens 232, and the target surface may be concave toward the object side and the image formation surface may be convex toward the image side. That is, the third lens 233 may have a meniscus shape that is convex toward the image side. The radius of curvature of the target surface of the third lens 233 may be different from the radius of curvature of the image formation surface. For example, the radius of curvature of the target surface may be greater than the radius of curvature of the image formation surface. However, the shape of the third lens 233 is not limited thereto.

The third lens 233 may be disposed closest to the image side among all the lenses included in the lens group 230.

At least one of the first lens 231 to the third lens 233 includes an aspheric lens, thereby reducing astigmatism, spherical aberration, coma aberration, distortion aberration, and the like occurring on the off-axis.

Meanwhile, the surfaces of the first lens 231 to the third lens 233 may be coated to prevent reflection or improve surface hardness.

Meanwhile, referring to FIGS. 6A and 6B, relative location of the catadioptric lens 220 and the lens group 230 may be fixed on the optical axis. In the optical device according to an embodiment of the present disclosure, when adjusting focus, the image sensor 300 may move in an object-side direction or an image-side direction on an optical axis to bring to a focus. Alternatively, the catadioptric lens 220 and the lens group 230 excluding the image sensor 300 may move in an object-side direction or an image-side direction on the optical axis to bring to a focus. In this case, the optical device may include a driving circuit for moving the image sensor 300 on the optical axis, or a driving circuit for moving the catadioptric lens 220 and the lens group 230 on the optical axis.

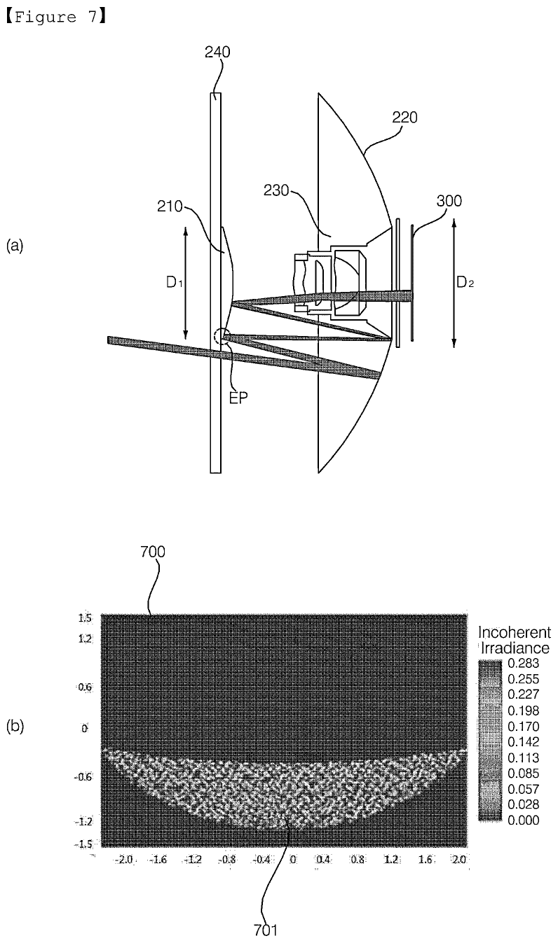

FIG. 7 illustrates various examples of the shape of the exit surface 224 included in the imaging lens 200 of FIG. 2.

Referring to FIG. 7, the exit surface 224 may be formed in a planar or aspherical shape.

When the exit surface 224 has an aspheric shape, the aspherical surface may be concave toward the image side or convex toward the image side.

Meanwhile, when the exit surface 224 has an aspheric shape, an inflection point may be formed on the exit surface 224. For example, the exit surface 224 may be convex toward the image side in the paraxial region and then concave toward an edge (FIG. 7B), or concave toward the image side in the paraxial region and then convex toward the edge (FIG. 7C). However, the shape of the exit surface 224 is not limited thereto.

Accordingly, astigmatism, spherical aberration, coma aberration, distortion aberration, and the like occurring on the off-axis may be reduced.

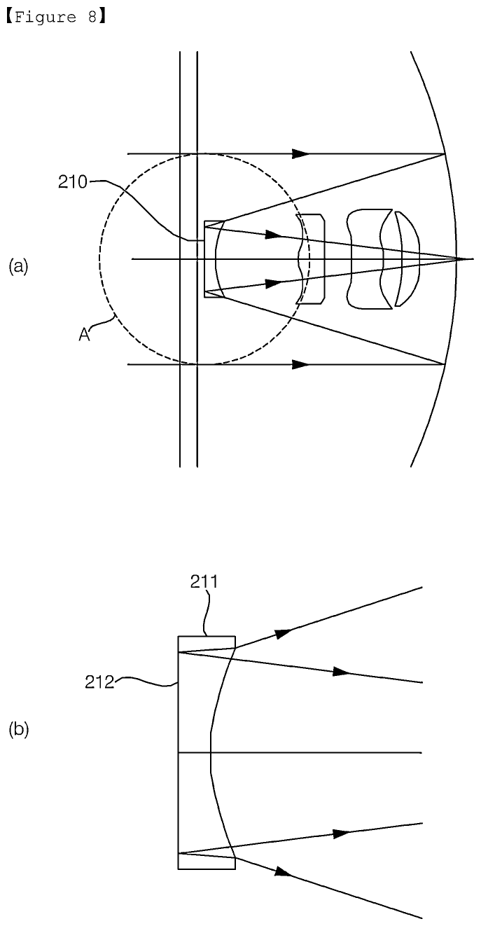

FIG. 8 illustrates an entrance pupil diameter (EPD) and a shielding area of the imaging lens 200 of FIG. 2.

The imaging lens 200 according to an embodiment of the present disclosure may satisfy the following conditional expression.

D2/EPD≤0.8

Here, EPD is the diameter of the entrance pupil of the imaging lens 200, and D2 is the diameter of the transmission area 226 of the second mirror surface 223. An entrance pupil diameter of the imaging lens 200 may be defined as an area through which a light that is vertically incident on the imaging lens 200 and incident on the image sensor 300 passes through the imaging lens 200.

In the imaging lens 200 of the present disclosure, Fno may be determined by the entrance pupil diameter and the size of the shielding area. The size of the shielding area may be determined by the diameter of the transmission area 226 of the second mirror surface 223. For example, the diameter of the shielding area may be proportional to the diameter of the transmission area 226 of the second mirror surface 223. For example, the diameter of the shielding area may be the same as the diameter of the transmission area 226 of the second mirror surface 223.

Referring to the drawing, an area where light is vertically incident on the imaging lens 200 may have a circular shape having an entrance pupil diameter EPD. Incident light may be blocked in proportion to the size of the transmission area 226 of the second mirror surface 223 at a central portion of the area where the light is incident. In this case, the shielding area may be formed in a circular shape at a central portion where light is incident.

When the diameter D2 of the transmission area 226 is ½ times the entrance pupil diameter EPD, the area S0 of the shielding area is about 25% of the total area S1 of the area on which light is incident. Therefore, in this case, about 75% of the total light incident on the imaging lens 200 may be incident on the image sensor 300. Accordingly, the imaging lens 200 designed in such a manner that the entrance pupil diameter (EPD) satisfies Fno 2.0 may actually have a brightness performance of approximately Fno 2.4.

Meanwhile, when the diameter D2 of the transmission area 226 is 0.8 times the entrance pupil diameter EPD, the area S0 of the shielding area is about 64% of the total area S1 of the area on which light is incident. Accordingly, in this case, about 36% of the total light incident on the imaging lens 200 may be incident on the image sensor 300. Accordingly, the imaging lens 200 designed in such a manner that the entrance pupil diameter EPD satisfies Fno 2.0 may actually have a brightness performance of approximately Fno 3.5.

When the D2/EPD value exceeds 0.8, the amount of light blocked by the shielding area increases. Therefore, even if the imaging lens 200 is designed in such a manner that the entrance pupil diameter satisfies Fno 2.0, it is difficult to actually implement brightness performance of Fno 3.5 or less.

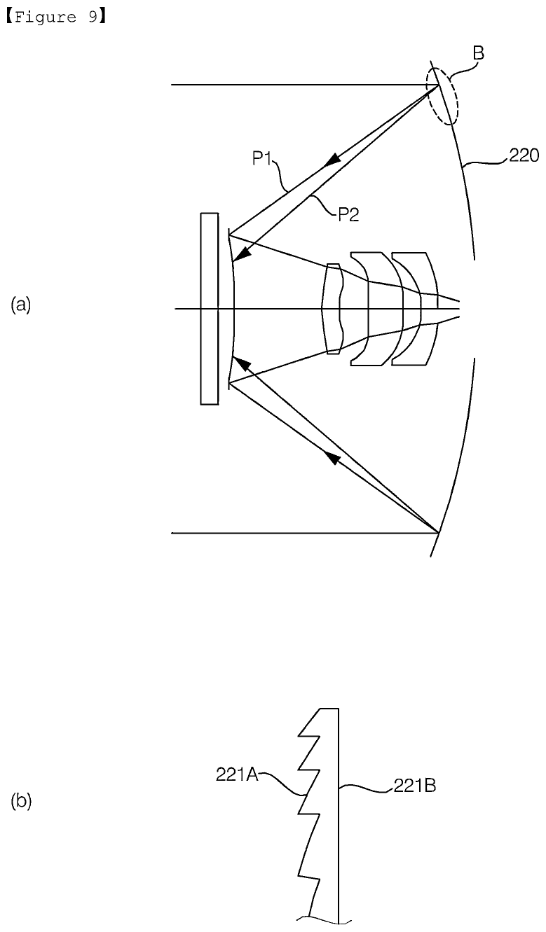

FIG. 9 illustrates a phenomenon in which stray light appears according to diameters of the first mirror surface 221 and the second mirror surface 223 in the imaging lens 200 of FIG. 2.

Specifically, FIG. 9A shows a part of the incident light path when the diameter of the first mirror surface 221 and the diameter of the second mirror surface 223 are the same, and FIG. 9B shows, in this case, a stray light that may appear in the photographed image.

The stray light means a light that causes an unnecessary noise-type shape in the image sensor 300 among light incident on the imaging lens 200. Therefore, if the imaging lens 200 is not properly designed, a noise component due to stray light may occur in an image photographed by using the imaging lens 200.

In the imaging lens 200 according to an embodiment of the present disclosure, the diameter D1 of the first mirror surface 221 may be smaller than the diameter D2 of the transmission area 226 of the second mirror surface 223.

Referring to FIG. 9A, when the diameter D1 of the first mirror surface 221 is equal to or greater than the diameter D2 of the transmission area 226 of the second mirror surface 223, a part of the light incident on the imaging lens 200 may be reflected by the second mirror surface 223 and reflected by the first mirror surface 221, and then reflected again by the second mirror surface 223 and the first mirror surface 221, and may be incident on the lens group 230. In the imaging lens 200 of the present disclosure, such light may be referred to as stray light.

In this case, stray light may be incident on the sensor surface of the image sensor 300 in a half-moon shape.

In FIG. 9B, the x and y axes indicates the horizontal axis and the vertical axis of the image sensor 300, respectively. Referring to FIG. 9B, when the diameter D1 of the first mirror surface 221 and the diameter D2 of the transmission area 226 of the second mirror surface 223 are the same, it can be seen that the stray light 901 is incident on the lower area of the image sensor 300 in a half-moon shape.

The half-moon-shaped stray light 901 may be formed larger on the image sensor 300, as the diameter D1 of the first mirror surface 221 becomes larger than the diameter D2 of the transmission area 226 of the second mirror surface 223. Therefore, in the imaging lens 200, the diameter D1 of the first mirror surface 221 is smaller than the diameter D2 of the transmission area 226 of the second mirror surface 223, so that the formation of stray light in a photographed image can be prevented. Accordingly, deterioration of the quality of the photographed image can be prevented.

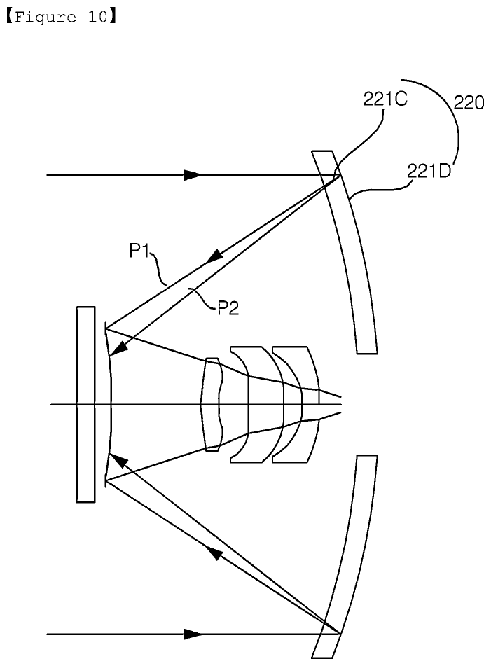

FIG. 10 shows various examples of the second mirror surface 223 in the imaging lens 200 of FIG. 2.

Referring to FIG. 2, the second mirror surface 223 may be a mirror that has a positive power, and has a concave object-side surface. The second mirror surface 223 may be a spherical mirror or an aspherical mirror. Since the concave aspherical mirror is a well-known structure in the related art, a detailed description thereof will be omitted.

Meanwhile, referring to FIG. 10, the second mirror surface 223 may be formed in the same shape as the surface of a diffractive element.

Referring to FIG. 10B, the second mirror surface 223 may be formed in the same shape as the surface of a diffractive element such as a Flanel lens. The second mirror surface 223 has a concave shape, and the surface may be formed in the shape of a flannel lens 221A. A reflective coating layer 221B capable of reflecting light may be formed on the second mirror surface 223.

Meanwhile, although not shown in the drawing, the second mirror surface 223 may be formed in the same shape as the surface of a diffractive optical element DOE. The second mirror surface 223 has a concave shape, and the surface may be formed in the form of a diffractive optical element. A reflective coating layer capable of reflecting light may be formed on the second mirror surface 223.

When the second mirror surface 223 is in the form of a flannel lens 221A or a diffractive optical element, an angle at which light is reflected from the second mirror surface 223 may increase.

FIG. 10A shows an optical path P1 in the case where the second mirror surface 223 has a general spherical or aspheric shape, and an optical path P2 in the case where the second mirror surface 223 is formed in the form of a flannel lens 221A or a diffractive optical element.

Referring to the drawing, when the second mirror surface 223 is formed in the form of a flannel lens 221A or a diffractive optical element, the light reflected from the second mirror surface 223 may be further refracted in the direction of the optical axis. Accordingly, the diameter of the first mirror surface 221 can be reduced, and the diameter or area of the shielding area of the imaging lens 220 can be reduced.

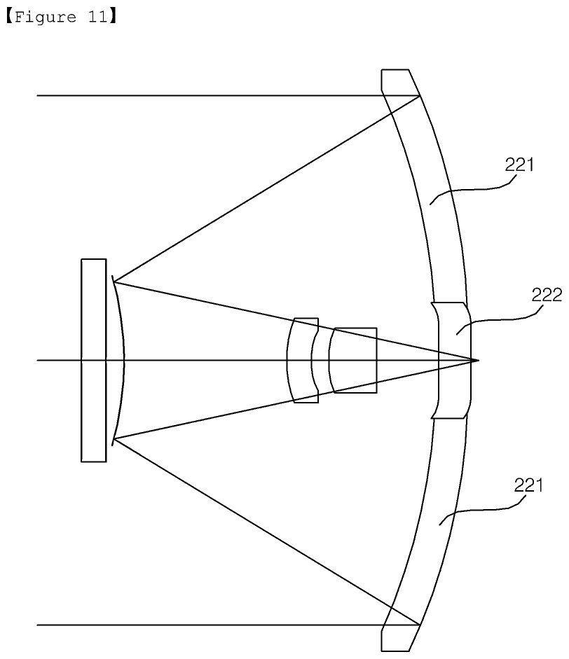

FIG. 11 shows various examples of the transmission area 226 of the second mirror surface 223 in the imaging lens 200 of FIG. 2.

Referring to FIG. 2, the second mirror surface 223 includes the transmission area 226. The transmission area 226 is an area through which light transmitted through the lens group 230 proceeds to the image sensor 300, and is formed at the central portion of the second mirror surface 223. The transmission area 226 may be an empty space.

Meanwhile, referring to FIG. 11, an optical element may be included in the transmission area 226. For example, at least one of a cover glass, a lens, a blue filter, an infrared filter, or a polarization filter may be located in the transmission area 226.

At least one lens may be included in the transmission area 226. The lens may refract incident light due to a shape of the lens and a difference in refractive index from an external material. The lens may include a spherical lens or an aspherical lens. Preferably, the lens may be implemented as an aspherical lens. At least one of the target surface and the image formation surface of the lens may have a convex shape, but the shape of the lens is not limited thereto.

The material of the lens may have the same material as that of the first lens 231 to the third lens 233 included in the lens group 230.

Accordingly, aberration or distortion of the image may be corrected by the lens included in the transmission area 226. Meanwhile, a blue filter, an infrared filter, or a polarization filter may be included in the transmission area 226. In this case, the amount of blue light incident on the image sensor 300 may be reduced by the blue filter, and the light incident on the image sensor 300 may be polarized by the polarization filter. However, various types of filters may be included in the transmission area 226 according to the purpose of use of the imaging lens 200, in addition to the blue filter, the infrared filter, and the polarization filter. Meanwhile, a cover glass may be included in the transmission area 226. The cover glass may protect the imaging surface of the image sensor 300.

Hereinafter, an embodiment of the imaging lens 200 of the present disclosure will be described.

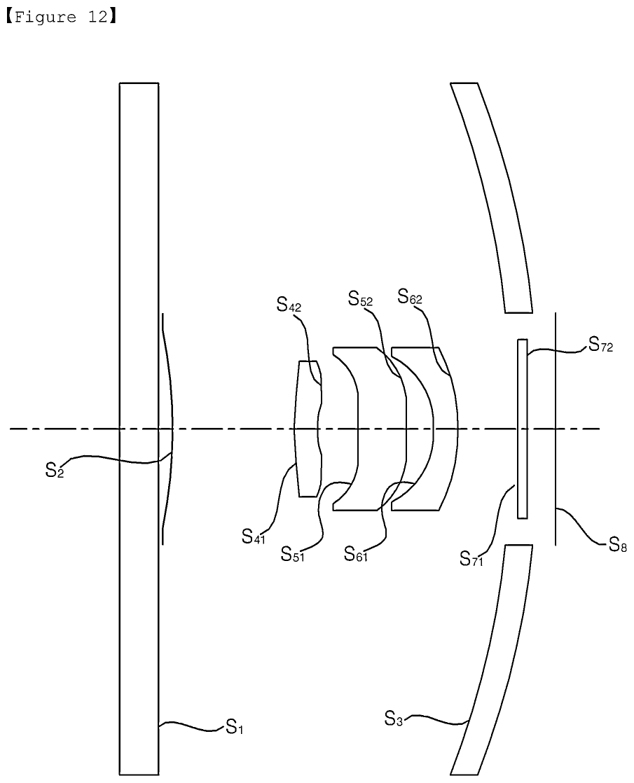

Design data of the imaging lens 200 of FIG. 12 are shown in Table 1 below. Table 1 shows the radius of curvature, thickness, or distance of each lens included in the imaging lens 200 according to an embodiment of the present disclosure. Here, the unit of the radius of curvature and thickness or distance is millimeters (mm).

TABLE 1

| | Radius of | Thickness or | |
|---|---|---|---|
| Surface | curvature (R) | distance (d) | Element |
| S1 | Infinity | 5.700 (S1-S4) | Incident surface |
| S2 | −14.00 | 1.600 (S2-S3) | First mirror surface |
| S3 | Infinity | 3.650 (S3-S4) | Exit surface |
| S4 | −5.200 | — | Second mirror surface |
| S9 | Infinity | — | Image surface |
| S51 | 10.70 | 0.380 | First lens |
| S52 | 2.600 | 0.230 | |
| S61 | 27.30 | 0.830 | Second lens |
| S62 | −11.80 | 0.800 | |
| S71 | −2.800 | 0.380 | Third lens |
| S72 | −10.00 | 0.300 | |
| S81 | Infinity | 0.110 | Filter |
| S82 | Infinity | 0.410 | |

In Table 1, the incident surface 222, the first mirror surface 221, the exit surface 224, the second mirror surface 223, and the curvature S1, S2, S3, S4, S9 and distance S1-S4, S2-S3, S3-S4 of the image sensor 300 are described, and the curvature (S51 to S82) and the thickness or distance of the target surface and the image formation surface of the first lens 231 to third lens 233 and the filter of the lens group 230 are described.

In the table, if the curvature is positive (+), it is the case of being convexly curved toward the object side, and if the curvature is negative (−), it is the case of being curved concavely toward the object side. If the curvature is infinity, it is the case where the surface is planar.

Referring to Table 1 and FIG. 12 together, the curvature of the incident surface 222 on the optical axis is infinite, the curvature of the first mirror surface 221 is −14, and the curvature of the second mirror surface 223 is −5.2. The incident surface S1 is disposed on the optical axis while being spaced apart by 5.700 mm by a point S4 where the second mirror surface intersects the optical axis, the first mirror surface S2 is disposed on the optical axis while being spaced apart by 1.600 mm from the exit surface S3, and the exit surface S3 is disposed on the optical axis while being spaced apart by 3.65 mm from the second mirror surface S4.

The distance (thickness) from the target surface S51 of the first lens to the image formation surface S52 on the optical axis is 0.380 mm, the distance (thickness) from the target surface S61 of the second lens to the image formation surface S62 is 0.830 mm, the distance (thickness) from the target surface S71 to the image formation surface S72 of the third lens is 0.380 mm, and the distance (thickness) from the target surface S81 of the filter to the image formation surface S82 is 0.110 mm.

Meanwhile, the image formation surface S52 of the first lens may be spaced apart by 0.230 mm from the target surface S61 of the second lens and be disposed on the optical axis, the image formation surface S62 of the second lens may be spaced apart by 0.800 mm from the target surface S71 of the third lens and be disposed on the optical axis, the image formation surface S72 of the third lens may be spaced apart by 0.300 mm from the target surface S81 of the filter and be disposed on the optical axis, and the image formation surface S82 of the filter may be spaced apart by 0.410 mm from the image surface S9 of the image sensor and be disposed on the optical axis.

In the first lens 231, the target surface S51 may be convex toward the object side, and the image formation surface S52 may be concave toward the image side. In the second lens 232, the target surface S61 may be convex toward the object side and the image formation surface S62 may be convex toward the image side. In the third lens 233, the target surface S71 may be concave toward the object side and the image formation surface S72 may be convex toward the image side.

Table 2 shows a conic constant k and aspheric coefficient of the lens surface of each lens included in the imaging lens 200 according to an embodiment of the present disclosure.

TABLE 2

| Surface | k | r⁴ | r⁶ |
|---|---|---|---|
| S2 | −1.40 | 0 | 0 |
| S4 | −11.6 | 0 | 0 |
| S51 | −60.0 | −0.200 | 0.090 |
| S52 | −17.5 | −0.240 | 0.030 |
| S61 | 0.00 | −0.220 | −0.020 |
| S62 | −1000 | −0.090 | 0.060 |
| S71 | 1.00 | −0.080 | 0.040 |
| S72 | −9.30 | −0.130 | 0.030 |

Referring to Table 2, the first mirror surface 221 and the second mirror surface 223 are aspheric, and the first lens 231 to the third lens 233 are aspherical lenses. However, at least one of the first mirror surface 221 and the second mirror surface 223 may be a spherical surface, and at least one of the first lens 231 to the third lens 233 may be a spherical lens, and is not limited to the example described in Table 2.

Meanwhile, referring to Table 3, it can be seen that the imaging lens 200 according to an embodiment of the present disclosure satisfies the above-described characteristics and conditional expressions. It can be seen that the imaging lens 200 is designed such that the entrance pupil diameter EPD satisfies Fno 2.0, and actually has a brightness performance of effective Fno 2.4.

Accordingly, the imaging lens 200 has improved optical performance, can be applied to an electronic device such as the mobile terminal 100 with a compact size, and can photograph a high-quality image in a dark environment.

TABLE 3

| EFL | 19.8 | mm |
|---|---|---|
| Fno | 2.0 (effective 2.4 @25% blocking) | |
| EPD | 9.9 | mm |
| TTL | 6.5 | mm |
| ICD (image circle diameter) | 4.0 | mm |

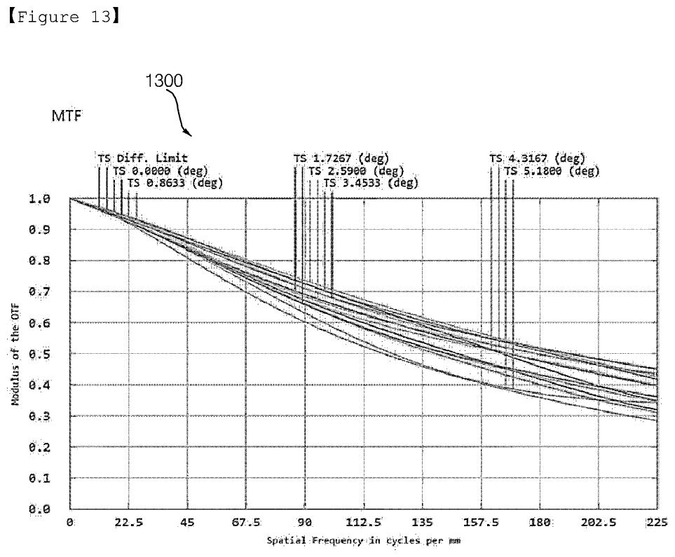

FIG. 13 shows a modulation transfer function (MTF) chart 1300 of the imaging lens 200 of FIG. 2.

In the drawing, each curve indicates a MTF curve (TS Diff. Limit in FIG. 13) of a diffraction limit and a MTF curve (TS_0.0000 (deg) to TS_5.1800 (deg) in FIG. 13) according to the incidence angle of a light incident on the imaging lens 200. In the curve, the X axis is a spatial frequency, the spatial frequency means the number of lines existing within 1 mm, and a unit is line pair per millimeter (lp/mm). The Y-axis indicates contrast.

Here, the diffraction limit indicates the absolute limit of lens performance. In a general lens, the MTF curve cannot rise above the diffraction limit, and it means that as the MTF curve approaches a diffraction limit curve, the optical performance is excellent.

In the case of the imaging lens 200 according to an embodiment of the present invention, as the angle of view increases, the effect of shielding incident light by the transmission area 226 of the second mirror surface 223 becomes different, so that a phenomenon of having an MTF value exceeding the diffraction limit occurs. In addition, due to the incident light shielding effect due to the transmission area 226 of the second mirror surface 223, the diffraction limit becomes lower in comparison with a general optical system having no shielding. As shown in a MTF chart 1300, in the imaging lens 200 of the present disclosure, MTF curves according to incident angle are all located near the MTF curve of the diffraction limit. That is, it can be seen that the optical performance of the imaging lens 200 according to an embodiment of the present disclosure is excellent.

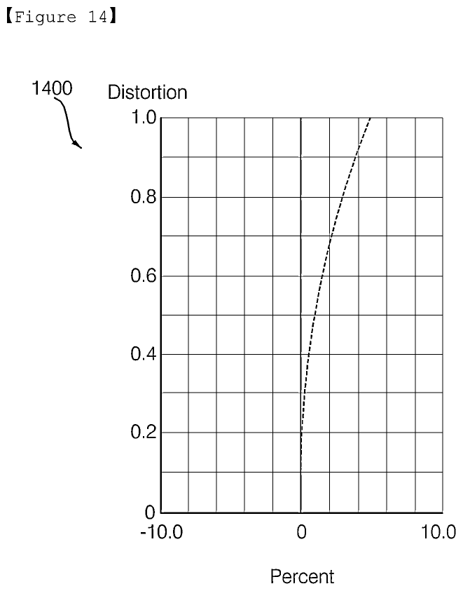

FIG. 14 is a graph 1300 showing distortion of the imaging lens 200 of FIG. 2.

In FIG. 14, the Y axis means the size of an image, and the X axis means a focal length (mm unit) and a degree of distortion (% unit). As each curve approaches the Y-axis, the aberration correction function of the imaging lens 200 may be improved. Referring to a graph 1400 of FIG. 14, the imaging lens 200 according to an embodiment of the present disclosure has a maximum distortion of 5% or less, and shows an excellent distortion. It can be seen that all of the lens group 230 is located between the first mirror surface 221 and the second mirror surface 223 to suppress an increase in the thickness of the imaging lens 220, and at the same time, and to suppress aberration generated in the imaging lens 220 as much as possible.

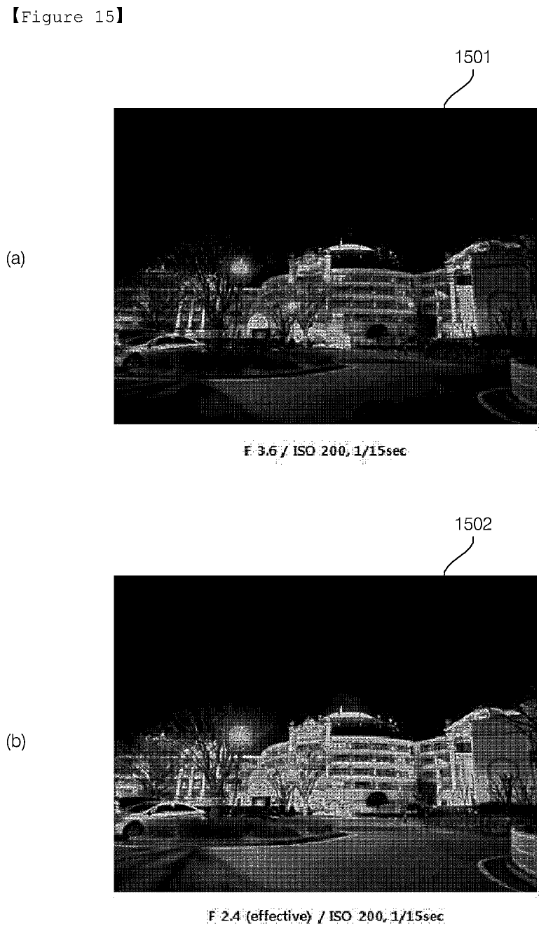

FIG. 15 shows a result of comparing an image photographed by using the imaging lens 200 of FIG. 2 with an image photographed by using a conventional lens.

FIG. 15A shows an image 1501 photographed by using a conventional imaging lens, and FIG. 15B shows an image 1502 photographed by using the imaging lens 200 according to an embodiment of the present disclosure.

Referring to FIG. 15A, an image 1501 photographed by using a conventional general imaging lens was photographed under the conditions of Fno 3.6, ISO 200, and shutter speed 1/15 sec. As can be seen in the image 1501, it can be seen that building, road, car, flower bed, and the like are darkly photographed because the amount of light necessary for photographing an image is insufficient.

Referring to FIG. 15B, an image 1502 photographed by using the imaging lens 200 according to an embodiment of the present disclosure was photographed under the conditions of the same ISO value and shutter speed, compared to the photographing condition of FIG. 15A. As can be seen in the image 1502, it can be seen that building, road, car, flower bed, and the like are photographed more brightly, compared to the image 1501 photographed by using a conventional imaging lens.

The imaging lens 200 of the present disclosure has an effective F number of 2.4, and the amount of light received by the lens is about twice (one step) larger than that of a conventional lens having an Fno of 3.6. This is because the imaging lens 200 of the present disclosure can improve the brightness performance of the lens by disposing all the lenses inside the catadioptric lens 220 including two mirror surfaces and increasing the entrance pupil diameter compared to a lens thickness.

Accordingly, under the same light condition and the same photographing condition, the imaging lens 200 of the present disclosure can receive a larger amount of light and obtain a brighter and clearer image.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

1. An imaging lens comprising:
a catadioptric lens on which light is incident from an object side, and through which light is reflected and emitted from the inside; and
a lens group comprising a plurality of lenses for transmitting the light emitted from the catadioptric lens to an image surface,
wherein the catadioptric lens comprises:
an incident surface on which light is incident from the object side;
a second mirror surface which is formed concave toward the object side, and reflects the light incident on the incident surface to a first mirror surface in the object side;
the first mirror surface which is formed, at a central portion of the incident surface, convex toward an image side, and reflects the light reflected from the second mirror surface toward the image side; and
an exit surface through which the light reflected from the first mirror surface is emitted,
wherein all of the lens group is disposed between the first mirror surface and the second mirror surface, based on an optical axis.

2. The imaging lens of claim 1, wherein the exit surface is formed in a planar or aspherical shape.

3. The imaging lens of claim 2, wherein a stop surface is located between the exit surface and a lens located closest to an image side among the plurality of lenses, on the optical axis.

4. The imaging lens of claim 2, wherein the exit surface is formed between the first mirror surface and the second mirror surface, based on an optical axis,
wherein the second mirror surface comprises a circular transmission area centered on an optical axis,
wherein the catadioptric lens further comprises a side surface connecting a boundary of the transmission area and a boundary of the exit surface,
wherein all of the lens group is disposed in a space, which is concave toward an image side, that is formed by the exit surface and the side surface.

5. The imaging lens of claim 4, wherein an absorption film is coated, or a diffuse pattern is formed on the side surface.

6. The imaging lens of claim 4, wherein a central point of the transmission area is located between an image side surface of a lens located closest to an image side among the plurality of lenses and the image surface, on the optical axis.

7. The imaging lens of claim 1, wherein the catadioptric lens is formed of a material having an Abbe number of 50 or more.

8. The imaging lens of claim 1, wherein the catadioptric lens is formed of a material having a coefficient of thermal expansion of less than or equal to 7×10-6/° C., or
a material having a mass per unit volume of 3 g/cm3 or less.

9. The imaging lens of claim 1, wherein the lens group comprises a first lens, a second lens, and a third lens,
wherein the first lens and the second lens are an aspherical, lense and
wherein the third lens is a Meniscus lens convex to the image side.

10. The imaging lens of claim 1, wherein a radius of curvature of the first mirror surface is greater than a radius of curvature of the second mirror surface.

11. The imaging lens of claim 1, wherein a diameter D1 of the first mirror surface is smaller than a diameter D2 of a transmission area of the second mirror surface.

12. The imaging lens of claim 1, wherein the lens group comprises a first lens located closest to the object side,
wherein a diameter DL1 of the first lens is the smallest among diameters of lenses comprised in the lens group and is smaller than a diameter D1 of the first mirror surface.

13. The imaging lens of claim 1, wherein when a diameter of the incident surface is D0 and a distance from the incident surface to the image surface is TTL,
a conditional expression of 0<TTL/D0≤0.7 is satisfied.

14. The imaging lens of claim 1, wherein when an entrance pupil diameter of the imaging lens is EPD and a diameter of transmission area of the second mirror surface is D2,
a conditional expression of D2/EPD≤0.8 is satisfied.

15. The imaging lens of claim 1, wherein a shape of the second mirror surface is in a shape of a flannel lens surface.

16. A camera module comprising:
an imaging lens according to claim 1,
a filter which selectively transmits light passed through the imaging lens according to a wavelength; and
an image sensor which receives the light passed through the filter.

17. An electronic device comprising the camera module of claim 16.
